(19) United States
(12) Patent Application Publication
(10) Pub. No.: US 2008/0239125 A1
(43) Pub. Date: Oct. 2, 2008

(54) IMAGE SENSOR SUITABLE FOR OPERATING IN SUBRESOLUTION MODE

(75) Inventor: Arnaud VERDANT, La Tour Du Pin (FR)

Correspondence Address: CANTOR COLBURN, LLP, 20 Church Street, 22nd Floor, Hartford, CT, 06103, US

(73) Assignee: COMMISSARIAT A L'ENERGIE ATOMIQUE, Paris (FR)

(21) Appl. No.: 12/055,825

(22) Filed: Mar. 26, 2008

(30) Foreign Application Priority Data
Mar. 26, 2007 (FR) 0754030

(51) Int. Cl. H04N 5/335

(52) U.S. Cl. 348/308; 348/E05.091

(57) ABSTRACT

“An image sensor suitable for operating in subresolution mode, including a plurality of pixels each formed of an elementary cell including a photodiode, and a reset transistor for connecting the photodiode to a reference voltage source, and a readout transistor connected to a column bus bar for acquiring the value of the charge of the photodiode, where the elementary cells are grouped in subsets forming macro-pixels, each subset having a common electrical connection, to which each elementary cell is able to connect by its reset transistor, in order to share the charges between the photodiodes of the elementary cells of said subset, said common electrical connection being suitable for connection to the reference voltage source.”

### FIELD OF THE INVENTION

The invention relates to the field of electronic image sensors and, more precisely, matrix sensors based on CMOS technology. It relates more particularly to a novel architecture of an image sensor, designed for operating in subresolution mode, while preserving high sensitivity.

In fact, operation in subresolution mode serves to produce images corresponding to a smaller volume of data, requiring less computer time for the processing operations, in particular for movement detection operations.

### PRIOR ART

In general, electronic image sensors comprise an array of elementary cells, arranged in matrix form and each including a photosensitive element whose exposure to light radiation causes the generation of an electric current.

More precisely, and as shown in FIG. 1, each cell (1), in its most simplified version, may comprise three transistors (T1, T2, T3) and a photodiode (D), arranged in an architecture commonly called “3T”. The image is captured at a given raster frequency by integrating the photon data at each diode (D) of each cell. At the start of each period, the photodiode (D) is precharged to a reference voltage, via the transistor (T1), also called “reset” transistor, which, when appropriately controlled, serves to connect the cathode of the diode (D) to a reference voltage source (V_{DD}). At the end of the integration, the transistor (T3) allows the selection of the cell concerned. When this transistor is a pass-transistor, the voltage of the photodiode is extracted on the column bus bar (B) via the transistor (T2) serving for impedance matching. Such a cell (1) or pixel has the advantage of only comprising three transistors, so that the filling factor of the photodiode remains high, insofar as the other components of the pixel only occupy a limited volume.

Furthermore, it is known that image sensors can be used in subresolution mode, meaning that the sensor delivers an image in which the light intensities detected by each of the pixels are averaged by grouping the pixels in subsets, in order to deliver an image comprising a smaller total number of pixels.

Various techniques are known for this averaging directly at the pixel subsets, also called macro-pixels.

According to a first technique, the pixel matrix is associated with a capacitance array installed at the end of the matrix, each array capacitance being connected to a column of the matrix. At the end of the readout step, the average of the voltages delivered by a set of selected elementary pixels is calculated by connecting this pixel subset to an average array capacitance. Examples of this type of operation are described in particular in the document “Multiresolution Image Sensor ”, IEEE Transaction on circuits and systems for video technology volume 7, No. 4, August 1997, or U.S. Pat. No. 6,839,452.

However, this technique has the drawback of requiring additional components to those of the pixels, that is the capacitance array, which is located outside the pixel matrix. The presence of this capacitance array therefore increases the volume of the sensor, and above all, causes a dissipation of the energy due to the currents which transit on the column bus bar outside this averaging operation. Furthermore, each pixel is located at a distance from the capacitance array that depends on its position in the matrix, so that the length of the bus bar traveled may cause slight variations in the average obtained.

Another technique for this averaging consists in sharing the charges between neighboring pixels, by placing the photodiodes of pixel subsets in parallel. Thus, the document “Multiresolution CMOS Image Sensor”, Technical digest of SPIE Opto-Canada 2002, Ottawa, Ontario, Canada 9, 10 May 2002, page 425 describes a pixel architecture for performing this averaging operation. More precisely, each pixel comprises a storage MOS capacitance, which is supplied by the photodiode, and which may be connected to the neighboring pixels by means of additional transistors provided for the purpose.

A similar technique is described in document US 2004/0095492. This technique overcomes the drawbacks mentioned for the solutions of capacitance arrays located at the end of a column. However, this solution is not fully satisfactory, insofar as the pixels include several additional transistors, required for connection to the adjacent pixels. Thus, the larger number of transistors increases the complexity of such a sensor. Furthermore, the semiconductor area occupied by these additional transistors commensurately decreases the photodiode filling factor and hence the sensitivity of the sensor, at equivalent total sensor volume. Furthermore, due to the connection of the pixels together by means of supplementary transistors, only the connection with the directly adjacent pixels in a predefined pattern is possible.

### SUMMARY OF THE INVENTION

It is one object of the invention to provide an image sensor for operating in subresolution mode, by therefore averaging the charges generated by several pixels, without requiring the use of numerous additional components, nor increasing the power consumption substantially. A further objective of the invention is to permit operation in subresolution mode, while preserving reduced pixel sizes, and while preserving a high sensitivity, due to an optimal filling factor.

The invention therefore relates to an image sensor suitable for operating in subresolution mode, comprising a plurality of pixels each formed of an elementary cell including a photodiode, and a reset transistor for connecting the photodiode to a reference voltage source, and a readout circuit connected to a column bus bar for acquiring the value of the charge of the photodiode.

According to the invention, this sensor is characterized in that the elementary cells are grouped in subsets forming macro-pixels, each subset comprising a common electrical connection, to which each elementary cell is able to connect by its reset transistor, in order to share the charges between the photodiodes of the elementary cells of said subset, said common electrical connection being suitable for connection to the reference voltage source.

In other words, the invention consists in producing macro-pixels which include a circuit for sharing their charges, to which each of the elementary pixels is connected via its reset transistor. This common connection therefore serves on the one hand to share the charges for averaging in subresolution mode. The same circuit, when connected to the reference voltage source, serves to recharge each of the photodiodes by activating each of the reset transistors of the pixels concerned. It may therefore be noted that the macro-pixel averaging is carried out by using pixels of a standard configuration, that is with a limited number of transistors, typically three, or even four, for architectures commonly called 3T or 4T. Only one additional transistor is required for connecting the common macro-pixel charge sharing circuit to the reference voltage source. It may also be noted that the common electrical connection, whereby the charge sharing takes place, may adopt a wide variety of geometries, in order to produce macro-pixels of any shape, as opposed to the known macro-pixels of the prior art having a mainly rectangular shape.

In other words, the possibility of operating in subresolution mode is provided without substantially altering the photodiode filling factor, because only one transistor is required per macro-pixel.

Advantageously in practice, the readout circuit may comprise a follower transistor, or more generally, an arrangement for detecting the data relative to the charge of the photodiode, despite the low capacitance thereof.

In a preferred embodiment, the readout circuit may be connected to the column bus bar via a selection transistor.

In practice, the common electrical connections forming the discharge circuits of a macro-pixel can be produced in various alternatives.

Thus in a first embodiment, the common electrical connections may comprise a plurality of parallel tracks to which elementary cells belonging to the same line or the same column of the pixel matrix are connected. These tracks are thus connected together by a connecting track that is substantially perpendicular to them. This connecting track may thus be placed at the border of the macro-pixel or as an alternative, at the center of the macro-pixel.

In another exemplary embodiment, each macro-pixel may comprise a plurality of connecting tracks, connecting the parallel tracks each assigned to a line or a column. In other words, a meshed network is thereby created, serving to reduce the total resistance of the common charge sharing circuit between two diodes.

In other words, a mesh is thereby obtained around the pixels, in order to place each of the branches of the charge sharing network in parallel. At the same time, the equivalent resistance between the reference voltage source and the reset transistors is reduced.

In another exemplary embodiment, the various parallel tracks of the common charge sharing circuit in a macro-pixel may be connected to the common connecting track optionally via an additional transistor. In this case, each of the lines or columns assigned to a track may be connected individually to the reference voltage source. This configuration serves to reduce the voltage drop when the photodiodes are recharged, because it limits the length of the track separating each of the pixels with regard to the reference voltage source. In other words, this alternative consists in arranging one connection to the reference voltage source per line.

As already stated, due to the fact that the charge circuits are made by the tracks in the chip comprising the sensor, these networks can assume a wide variety of shapes, depending on the desired characteristics. It is thus possible to produce macro-pixels which have a rectangular configuration, or extending in a direction diagonal to the matrix. It is also possible to produce more specific shapes, for example allowing a sharing of charges on a substantially circular or polygonal zone, a shape which may be more suitable for performing specific functions relative to the mathematical morphology for example.

According to another feature of the invention, the sensor may comprise additional electrical connections, to each of which the common electrical connections of several subsets of the elementary cells can be connected. In other words, it is possible to produce charge sharing networks of a higher rank to which the charge sharing networks of several macro-pixels can be connected. In other words, it is thereby possible to produce sharing networks between several macro-pixels, in order to generate macro-pixels of larger size. Thus, the subresolution depth can be adjusted as required. Obviously, the same principle can be applied to produce interleaved networks recursively on various levels, in order to select the size of the macro-pixels, and the subresolution level.

### BRIEF DESCRIPTION OF THE DRAWINGS

The manner in which the invention can be implemented and the advantages thereof will appear clearly from the description of exemplary embodiments that follow, in conjunction with the appended figures provided for information and nonlimitinig, in which:

FIG. 1 is a simplified wiring diagram showing the constitution of all elementary pixel;

FIG. 2 is a simplified diagram showing a fraction of an image sensor according to the invention,

FIGS. 3 to 5 are simplified diagrams of a macro-pixel showing several exemplary embodiments of a common discharge circuit;

FIG. 6 is a schematic view of a macro-pixel consisting of nine smaller macro-pixels.

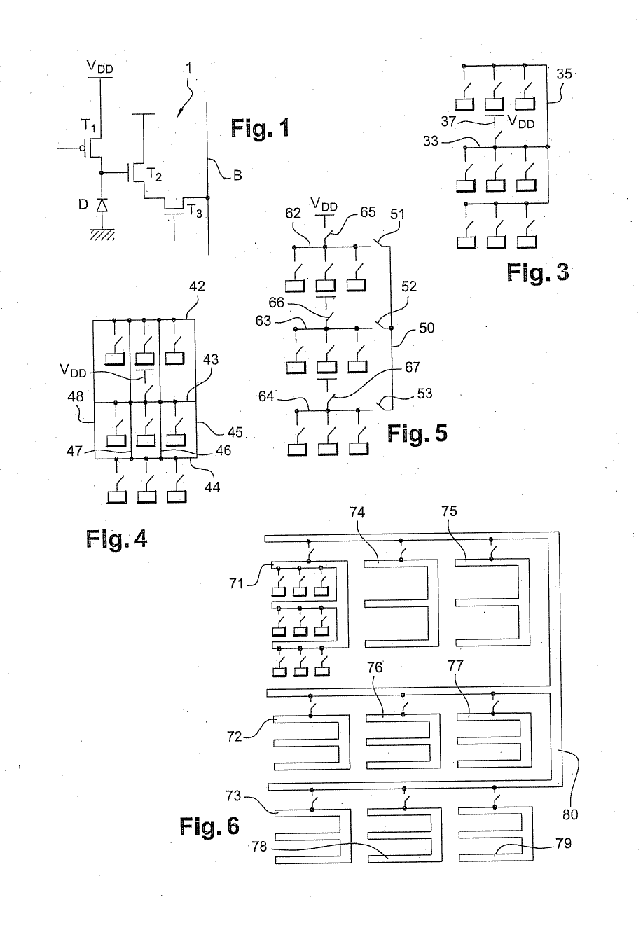

### DETAILED DESCRIPTION OF THE INVENTION

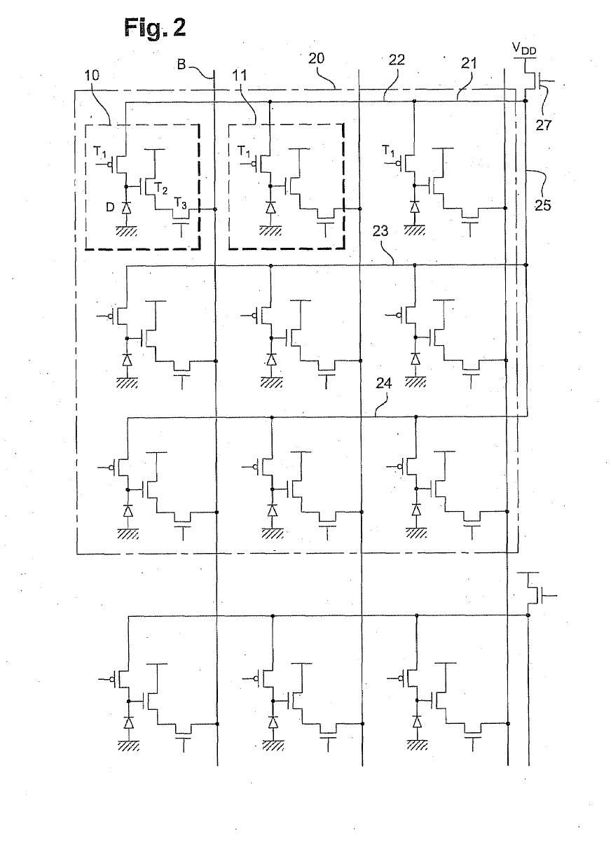

Conventionally, the image sensor according to the invention comprises, as shown in FIG. 2, a plurality of elementary pixels (10), (11) shown by areas in dotted lines. Each elementary pixel comprises a photodiode (D) whose cathode is connected to the grid of a follower transistor (T₂) for converting the photodiode charge into a current. When the selection transistor (T₃) is a pass-transistor, this follower transistor delivers to a column bus bar (B₁).

According to the invention, the various elementary pixels are grouped in subsets, in order to define macro-pixels (20), which in the embodiment shown, comprise nine elementary pixels.

More precisely, each macro-pixel comprises a common electrical connection, a charge sharing network (21). In the embodiment shown in FIG. 2, this network (21) is formed of three tracks (22), (23), (24) parallel to the pixel lines and connected to one end of the connecting track (25) parallel to a column. Thus, each pixel is connected to this sharing network by its reset transistor (T₁).

Complementarily, the charge sharing network (21) may be connected to the reference voltage source (V_{DD}) via a transistor (27) specific to the macro-pixel (10).

In addition, when the sensor operates in high resolution mode, this transistor (27) is a pass-transistor, so that the charge sharing network (21) is at the potential of the reference voltage source (V_{DD}). By an appropriate control of the reset transistor (T₁) of each of the pixels of the macro-pixel, the photodiodes are recharged, before proceeding with image acquisition. Each of the connecting transistors (T₃) to the column bus bar is open. In a second phase after recharge of the photodiodes, the reset transistors (T₁) are open so that the individual integration of the light intensity is then carried out for each pixel. The charge thus varies individually in the photodiodes (D).

Then, at the end of the integration, the selection transistors (T₃) for connecting each pixel to the column bus bar (B) are each closed in turn, so that the data acquired at each pixel is transmitted in multiplexed form to each column bus bar.

Conversely, when the sensor operates in subresolution mode, the reset transistors (T₁) are closed for all the pixels of the macro-pixel. Initially, the photodiode (D) array is recharged by closing the transistor (27) connecting the sharing network (21) to the reference transmission source (V_{DD}). Then, in a second phase, this transistor (27) is open. After exposure to light radiation, a parallelized integration is performed between all the photodiodes of the pixels of the macro-pixel, with instantaneous sharing of the charges of the various photodiodes. At the end of the integration, one of the connecting transistors (T₃) to the column bus bar is closed, in order to allow the acquisition of the charge value. Since each pixel has the same common data with regard to the macro-pixel, the acquisition at a single elementary pixel is sufficient.

As already stated, the geometry of the charge sharing network can be prepared in various ways, concerning its shape, and the connections between its various portions.

Thus, as shown in FIG. 3, which corresponds to an alternative of FIG. 2, the transistor (37) for connection to the reference voltage source may be located not at the branch of the side connection (35), but at one of the lines, and more particularly, the central line (33). In this case, the voltage drop between the power supply source and the most distant pixel is limited.

As an alternative, as shown in FIG. 4, it is possible to supplement the sharing network with additional lines (45-48), perpendicular to the tracks (42-44) parallel to the lines. In this way, a mesh is produced for reducing the voltage drop in this charge sharing network, between the reference source (V_{DD}) and the various pixels.

However, this lowering of the resistance of the charge sharing circuit results in an increase in its capacitance. Thus, this sharing network is produced by seeking to minimize its equivalent capacitance, to prevent it from having an excessive influence on the total capacitance of the macro-pixel, which combines the capacitances of each of the photodiodes. Thus, in an optimized manner, in order to combine operation in a nominal resolution and in subresolution, it is possible to produce an average after a nominal high resolution readout of each of the pixels. For this purpose, a reset is required on this charge sharing network before the connection of each of the pixels thereto via their reset transistor, in order to obtain a constant error in the generation of the average of the macro-pixel. In fact, it is preferable to set the value of the charge present on this bus bar to avoid the consideration of a random charge that would be stored in this charge shaking network.

In an alternative shown in FIG. 5, it is possible to use an additional transistor (51-53) for connection at the end of the line track, to separate the charge sharing between pixels of the same line, from the charge sharing between pixels of different lines. In this case, each line track (62-64) also comprises a transistor (65-67) for connection to the reference voltage. These transistors (65-67) are actuated in the same way as the reset transistors of each of the individual pixels. This configuration of the charge sharing network serves to reduce the power supply voltage drop associated with the size of the track (62-64) separating the pixel from the reference voltage source, by having one reference voltage source per line.

In a more evolved embodiment shown in FIG. 6, the charge sharing network (71-79) of several macro-pixels can be connected to the higher level of charge sharing network (80). In this case, the operation with regard to a group of macro-pixels takes place according to the same reasoning as discussed concerning one macro-pixel. Thus, when the higher level charge sharing network (80) provides the connection between the charge sharing networks (71-79) of several macro-pixels, all the macro-pixels concerned are placed in parallel. The average on this total set of pixels is then calculated. In other words, each pixel subset is connected to the reference voltage (V_{dd}) by two (or more) switches, the first at the pixel subset and a second at a higher level grouping several pixel subsets. In general, this reasoning can be implemented recursively, in order to obtain increasing subresolution levels.

Obviously, the invention also covers alternatives in which the various pixels of a macro-pixel are not arranged in rectangular or square patterns. On the contrary, the sharing networks can be created in a highly varied manner, insofar as it only requires the creation of the tracks connecting the pixels together. It is thereby possible to produce macro-pixel patterns allowing greater ease, in particular in autocorrelation calculations, as described in the document “Higher Order auto correlation vision chip”, IEEE Transactions On Electron Devices, Volume 53, No. 8, August 2006, pages 1797-1804.

It appears from the above that the image sensor according to the invention has the advantage of allowing charge sharing without substantially altering the number of transistors per pixel, by only adding one transistor per macro-pixel. Moreover, the charge sharing in the matrix between pixels is not limited to the nearest neighbor, because the characteristic sharing network allows remote connection of the pixels, thereby creating macro-pixels of complex shape. Furthermore, the structure of the macro-pixels allows a hierarchical construction facilitating operations at various subresolution levels.

1. An image sensor suitable for operating in subresolution mode, comprising
a plurality of pixels each formed of an elementary cell including a photodiode, and a reset transistor for connecting the photodiode to a reference voltage source, and
a readout circuit connected to a column bus bar for acquiring a value of a charge of the photodiode,
wherein the elementary cells are grouped in subsets forming macro-pixels, each subset comprising a common electrical connection, to which each elementary cell is able to connect by its reset transistor, in order to share the charges between the photodiodes of the elementary cells of said subset, said common electrical connection being suitable for connection to the reference voltage sources.

2. The sensor as claimed in claim 1, the readout circuit comprises a follower transistor.

3. The sensor as claimed in claim 1, wherein the readout circuit is connected to the column bus bar via a selection transistor.

4. The sensor as claimed in claim 1, wherein the common electrical connections comprise a plurality of parallel tracks to which elementary cells belonging to the same line or column are connected, said tracks being interconnected by a connecting track.

5. The sensor as claimed in claim 4, wherein each subset comprises a plurality of connecting tracks (45-48) connecting the tracks assigned to a line or to a column.

6. The sensor as claimed in claim 4, wherein the connecting track is connecting to the tracks assigned to a line or column via a transistor.

7. The sensor as claimed in claim 1, wherein the elementary cells of a subset are arranged spatially in a rectangular configuration.

8. The sensor as claimed in claim 1, wherein the elementary cells of a subset are arranged spatially in a diagonal direction to the matrix.

9. The sensor as claimed in claim 1, further comprising electrical connections to each of which the common electrical connections of a plurality of subsets of elementary cells can be connected.
